(19) United States
(12) Patent Application Publication
(10) Pub. No.: US 2023/0381758 A1
(43) Pub. Date: Nov. 30, 2023

(54) METHOD FOR PREPARING AN IZM-2 BASED CATALYST BY A SPECIFIC HEAT TREATMENT AND USE OF SAID CATALYST FOR THE ISOMERISATION OF PARAFFINIC FEEDSTOCKS TO MIDDLE DISTILLATES

(71) Applicant: IFP Energies nouvelles, Rueil-Malmaison Cedex (FR)

(72) Inventors: Fabrice DIEHL, Rueil-Malmaison Cedex (FR); Christophe BOUCHY, Rueil-Malmaison Cedex (FR)

(73) Assignee: IFP Energies nouvelles, Rueil-Malmaison Cedex (FR)

(21) Appl. No.: 18/032,851

(22) PCT Filed: Oct. 11, 2021
(86) PCT No.: PCT/EP2021/077981

§ 371 Date: Apr. 20, 2023

(30) Foreign Application Priority Data
Oct. 23, 2020 (FR) 2010896

(51) Int. Cl. B01J 29/74; B01J 37/08; B01J 37/00; C10G 45/62; C10G 45/64; B01J 37/02

(52) U.S. Cl. CPC B01J 29/74; B01J 37/08; B01J 37/0009; C10G 45/62; C10G 45/64; B01J 37/0203; C10G 2300/1085; C10G 2300/4006; C10G 2300/4012; C10G 2300/4018; B01J 2229/34; B01J 2229/40

(57) ABSTRACT

The present invention relates to a method for preparing a bifunctional catalyst using an IZM-2 zeolite, a hydrogenating function and a matrix. The preparation method according to the invention uses a specific heat treatment of the catalyst which improves its selectivity for the isomerisation of paraffinic feedstocks in middle distillates.

### TECHNICAL FIELD

In order to meet the demand for middle distillate bases, i.e. a fraction that can be incorporated into the kerosene and/or gas oil pool, various methods for producing middle distillates based on the use of petroleum, natural gas or renewable resources may be used.

Middle distillate bases may thus be produced from a paraffinic feedstock obtained from a feedstock derived from renewable sources, and in particular from plant oils or animal fats, which are crude or which have undergone a pretreatment, and also mixtures of such feedstocks. Specifically, said feedstocks derived from renewable sources contain chemical structures of triglyceride or free fatty acid or ester type, the structure and length of the hydrocarbon-based chain of these feedstocks being compatible with the hydrocarbons present in middle distillates. Said feedstocks derived from renewable sources produce, after hydrotreatment, paraffinic feedstocks that are free of sulfur compounds and of aromatic compounds. These paraffinic feedstocks are typically composed of linear paraffins containing between 9 and 25 carbon atoms.

Middle distillate bases may also be produced from natural gas, coal or renewable sources via the Fischer-Tropsch synthesis process. In particular, the “low-temperature” Fischer-Tropsch synthesis using cobalt catalysts makes it possible to produce essentially paraffinic linear compounds having a very variable number of carbon atoms, typically from 1 to 100 carbon atoms or even more. Separation steps may make it possible to recover paraffinic feedstocks containing between 9 and 25 carbon atoms.

However, these middle distillate bases obtained after hydrotreatment of plant oils or after the low-temperature Fischer-Tropsch synthesis process generally cannot be incorporated as such into the kerosene or gas oil pool in particular on account of inadequate low-temperature properties. Specifically, high molecular weight paraffins which are linear or very sparingly branched and which are present in these middle distillate bases lead to high pour points and thus to solidifying for uses at low temperature. For example, the pour point of a linear hydrocarbon containing 20 carbon atoms per molecule and whose boiling point is equal to about 340° C., i.e. typically within the middle distillate cut, is about +37° C., which renders its use impossible, the specification being −15° C. for gas oil. In order to lower the pour point values, these linear or very sparingly branched paraffins must be totally or partially removed.

This operation may be performed by extraction with solvents such as propane or methyl ethyl ketone, this process then being referred to as propane dewaxing or methyl ethyl ketone (MEK) dewaxing. However, these techniques are expensive, lengthy and not always easy to perform.

Selective cracking of the longest linear paraffinic chains, which leads to the formation of compounds of lower molecular weight, a portion of which may be removed by distillation, is one solution for reducing the pour point values. Given their shape selectivity, zeolites are among the catalysts most widely used for this type of process. The catalyst that is the most widely used in the category of dewaxing by selective cracking is zeolite ZSM-5, of MFI framework type, which has three-dimensional porosity, with medium pores (aperture containing 10 oxygen atoms, 10MR). However, the cracking brought about in such processes leads to the formation of large amounts of products of lower molecular weights, such as butane, propane, ethane and methane, which considerably reduces the yield of desired products.

Another solution for improving the low-temperature behavior consists in isomerizing long linear paraffins while minimizing the cracking as much as possible. This may be achieved by performing a hydroisomerization process using bifunctional catalysts. The bifunctional catalysts involve a Brønsted acid phase (for example a zeolite) and a hydrogenating-dehydrogenating phase (for example platinum) and generally a matrix (for example alumina). The appropriate choice of the acid phase makes it possible to promote the isomerization of long linear paraffins and to minimize the cracking. Thus, the shape selectivity of medium-pore (10MR) one-dimensional zeolites such as zeolites ZSM-22, ZSM-23, NU-10, ZSM-48 and ZBM-30 makes them particularly suitable for use for obtaining catalysts that are selective toward isomerization.

Recently, the applicant has also discovered that the use of IZM-2 zeolite is also suitable for obtaining catalysts that are selective toward the isomerization of long paraffins.

### PRIOR ART

However, it is well known that factors other than the acid phase have an impact on the activity and selectivity of a bifunctional catalyst. Hydroisomerization and hydrocracking of normal paraffins have thus been the subject of numerous academic studies since the original investigations in the 1960s by Weisz or Coonradt and Garwood. The most commonly accepted mechanism first involves dehydrogenation of the n-paraffin to an n-olefin on the hydrogenating-dehydrogenating phase and then, after diffusion to the acid phase, protonation to a carbenium ion. After structural rearrangement and/or β-scission, the carbenium ions are desorbed from the acid phase in the form of olefins after deprotonation. Next, after diffusion to the hydrogenating-dehydrogenating phase, the olefins are hydrogenated to form the final reaction products. When maximum isomerization selectivity is desired, the cracking reactions on the acid phase should be limited. It is then advisable to have a hydrogenating/dehydrogenating function that is sufficiently active with respect to the acid function, and sufficiently similar to the acid function, so as to rapidly hydrogenate the olefinic intermediates. When the overall reaction rate is only controlled by the steps catalyzed by the acid function, the bifunctional catalyst is said to be “ideal”. When this is the case, for a given acid function, the activity and the isomerization selectivity of the catalyst are then dictated by the properties of the acid phase. This case is thus well known and reported in the academic literature, in the case of the isomerization of long paraffins such as n-hexadecane for example (see for example P. S. F. Mendes et al., AIChE Journal, 63 (2017), 7, 2864-2875 and references cited). However, the hydrogenating/dehydrogenating function can also catalyze reactions such as the hydrogenolysis of paraffins. This reaction is unwanted because it can lead to a decrease in the isomerization selectivity of the bifunctional catalyst. Industrial bifunctional catalysts using a zeolite acting as the acid phase and a noble metal acting as the hydrogenating function are typically prepared by shaping the zeolite with a matrix, which may be alumina, in order to obtain a shaped support, then deposition of the metallic phase on said support by impregnation. Generally, the heat treatment steps associated with shaping the support and depositing the metallic function involve bringing the solid into contact with a gas that may contain oxygen (in the case of a calcination) or hydrogen (in the case of a reduction). Generally, these heat treatment steps are carried out in the absence of chlorine or chlorinated compounds and water in the gaseous medium, in order to preserve the crystalline structure of the zeolite and avoid the dealumination thereof. The resistance to dealumination of the zeolite depends on its structure, its form (acid or non-acid), the temperature and the presence of chlorine or chlorinated compounds and water (see R. Lopez-Fonseca et al., Applied Catalysis B: Environmental 30, (2001), 303-313 and Z. Konya et al., Applied Catalysis B: Environmental, 8 (1996), 391-404). Heat treatments using the presence of chlorine or chlorinated compound in the gaseous medium are reported in the context of the regeneration of spent catalysts using a noble metal and a zeolite. These treatments aim to redisperse the noble metal which may have been sintered during the use of the catalyst. These so-called oxychlorination heat treatments are carried out after an initial controlled calcining heat treatment of the spent catalyst, which aims to eliminate the coke present on the spent catalyst.

Patent application WO 94/05419 discloses a regeneration protocol for a reforming catalyst using a group VIII metal and a zeolite. This regeneration protocol comprises a combustion step to eliminate the coke and then a heat treatment in the presence of water, a source of chlorine, oxygen and an inert gas.

Patent FR 2874516 discloses a process for regenerating a catalyst comprising at least one zeolite with framework code EUO and at least one hydrogenating-dehydrogenating metal. This process comprises a step of eliminating most of the coke by combustion in the presence of an oxygen-containing gas at less than 600° C., followed by a step of oxychlorination in the presence of a gas mixture containing at least water, oxygen and chlorine and/or at least one chlorinated compound.

U.S. Pat. No. 4,645,761 discloses a catalyst rejuvenation protocol comprising an alumina matrix, a noble metal and a zeolite with a silica to alumina mole ratio of at least 20. This protocol comprises a step of reducing the catalyst under hydrogen followed by a step of redispersing the metallic phase in the presence of a gas containing from 1% to 20% by volume of oxygen and from 0.001% to 10% by weight of hydrogen halide.

Patent WO 9847615 teaches a process for improving the catalytic activity of a catalyst containing an L-type zeolite and at least one group VIII metal. This process comprises bringing said catalyst into contact with a gaseous medium comprising water, a source of chlorine, oxygen and an inert gas between 450° C. and 550° C. The product thus obtained is brought into contact with a gaseous medium comprising water, oxygen and an inert gas between 450° C. and 550° C. in order to reduce the content of chlorine on the catalyst to a value of less than 2% by weight. Finally, the solid is reduced between 350° C. and 550° C. by a gas containing hydrogen and an inert gas in order to obtain the metal in its reduced form.

During its investigations performed to improve the selectivity of isomerization of long paraffins and the activity of bifunctional catalysts using IZM-2 zeolite as acid function, the applicant has discovered a surprising impact of the catalyst preparation protocol on the isomerization selectivity of said bifunctional catalysts using IZM-2 zeolite, the activity of said catalysts being at least maintained.

Thus, the present invention relates to a process for preparing a bifunctional catalyst using an IZM-2 zeolite, a hydrogenating function comprising at least one noble metal from group VIII and a matrix.

Another subject of the present invention relates to the catalyst obtained via said process.

Another subject of the present invention relates to a process for the isomerization of paraffinic feedstocks derived from hydrotreated plant oils and/or animal oils or from low-temperature Fischer-Tropsch synthesis, said process using said bifunctional catalyst.

Surprisingly, the preparation process of the invention makes it possible to improve the isomerization selectivity of the catalyst while retaining its activity.

### SUMMARY OF THE INVENTION

The present invention relates to a process for preparing a bifunctional catalyst comprising an acid function constituted by IZM-2 zeolite, a hydrogenating function comprising at least one noble metal from group VIII of the Periodic Table, chosen from platinum and palladium, and a matrix, said process comprising at least the following steps:
i) a step of preparing the support for the catalyst by shaping IZM-2 zeolite with a matrix such that the weight percentage of zeolite is advantageously between 1% and 50% relative to the weight of the support,
ii) a step of depositing at least one noble metal from group VIII of the Periodic Table by impregnation of the support prepared in step i), enabling a solid to be obtained, with an aqueous solution comprising at least the following compounds:
   at least one ammoniacal compound chosen from the platinum(II) tetramine salts of formula Pt(NH₃)₄(OH)₂, Pt(NH₃)₄(NO₃)₂ or Pt(NH₃)₄X₂, the platinum(IV) hexamine salts of formula Pt(NH₃)₆X₄; the platinum(IV) halopentamine salts of formula (PtX(NH₃)₅)X₃; the platinum N-tetrahalodiamine salts of formula PtX₄(NH₃)₂; and the halogenated compounds of formula H(Pt(acac)₂X); the palladium(II) salts Pd(NH₃)₄SO₄ or Pd(NH₃)₄X₂, wherein X is a halogen chosen from chlorine, fluorine, bromine and iodine, X preferably being chlorine, and “acac” represents the acetylacetonate group (of empirical formula C₅H₇O₂), an acetylacetone-derived compound,
iii) at least one heat treatment step wherein the solid prepared in step ii) is brought into contact with at least one gas mixture containing oxygen, water, chlorine and/or at least one chlorinated compound, said heat treatment step being carried out at a temperature between 200° C. and 1100° C.

An advantage of the present invention is to provide a process for preparing a bifunctional catalyst comprising an acid phase based on IZM-2 zeolite and a hydrogenating function based on noble metals from group VIII, which, by means of performing the heat treatment of step iii), makes it possible to improve the long-paraffin isomerization selectivity of the catalyst, the activity of said catalyst being at least maintained.

Without wishing to be bound by any theory, the applicant believes that the improvement in the long-paraffin isomerization selectivity of the catalyst and the maintaining of its activity are obtained by means of the combination of the steps carried out in the process according to invention, and in particular steps ii) and iii). The systematic improvement in the maximum isomerization yield observed appears to be linked to a reduction in the hydrogenolysing activity of said catalysts in accordance with the invention.

Another advantage of the present invention is to provide a process for the isomerization of paraffinic feedstocks derived from hydrotreated plant oils and/or animal oils or from the low-temperature Fischer-Tropsch synthesis using said bifunctional catalyst thus obtained, making it possible to obtain a better selectivity for middle distillates by means of the use of the heat treatment of step iii), the activity of said catalyst being at least maintained.

### DETAILED DESCRIPTION OF THE INVENTION

In accordance with the invention, the present invention relates to a process for preparing a bifunctional catalyst comprising an acid function constituted by IZM-2 zeolite, a hydrogenating function comprising at least one noble metal from group VIII of the Periodic Table, chosen from platinum and palladium alone or as a mixture, and a matrix.

### The Catalyst

The catalyst prepared according to the invention comprises IZM-2 zeolite which constitutes the acid function of said catalyst. IZM-2 zeolite has a crystalline structure.

IZM-2 zeolite is a crystalline microporous solid having a crystal structure described in patent application FR 2 918 050. The process for preparing IZM-2 zeolite is also described in said patent application.

Said solid IZM-2 exhibits a chemical composition, expressed on an anhydrous basis, in terms of moles of oxides, defined by the following general formula: XO₂:aY₂O₃:bM₂/nO, wherein X represents at least one tetravalent element, Y represents at least one trivalent element and M is at least one alkali metal and/or one alkaline earth metal of valency n.

X is preferentially chosen from silicon, germanium, titanium and a mixture of at least two of these tetravalent elements. Very preferentially, X is silicon, and Y is preferentially chosen from aluminum, boron, iron, indium and gallium. Very preferentially, Y is aluminum. M is preferentially chosen from lithium, sodium, potassium, calcium, magnesium and a mixture of at least two of these metals, and very preferentially M is sodium. Preferably, X represents silicon; the crystalline solid IZM-2 according to the invention is then an entirely silicic solid when the element Y is absent from the composition of said solid IZM-2. It is also advantageous to use as element X a mixture of several elements X, in particular a mixture of silicon with another element X chosen from germanium and titanium, preferably germanium. Thus, when silicon is present as a mixture with another element X, the crystalline solid IZM-2 according to the invention is then a crystalline metallosilicate exhibiting an X-ray diffraction pattern identical to that described in table 1 when it is in its calcined form. Even more preferably and in the presence of an element Y, X is silicon and Y is aluminum: the crystalline solid IZM-2 according to the invention is then an aluminosilicate.

Preferably, the IZM-2 zeolite is in aluminosilicate form.

Preferably, the mole ratio of the number of silicon atoms to the number of aluminum atoms Si/Al is less than 200, preferably less than 150 and very preferably less than 120.

The IZM-2 zeolite included in the composition of the support for the catalyst prepared according to the invention is advantageously exchanged via at least one treatment with a solution of at least one ammonium salt so as to obtain the ammonium form of the IZM-2 zeolite, which, once calcined, leads to the acid (H⁺) form of said IZM-2 zeolite. This exchange step may be performed at any step in the preparation of the catalyst, i.e. after the step of preparing IZM-2 zeolite, after the step of shaping IZM-2 zeolite with a matrix, or even after the step of introducing the hydrogenating-dehydrogenating metal.

Said IZM-2 zeolite included in the composition of the support for the catalyst used in the process according to the invention is advantageously at least partly, and preferably virtually totally, in acid form, i.e. in acid (H⁺) form.

According to the invention, the catalyst prepared comprises at least one matrix. Said matrix may advantageously be amorphous or crystalline.

Preferably, said matrix is advantageously chosen from the group formed by alumina, silica, silica-alumina, clays, titanium oxide, boron oxide and zirconia, taken alone or as a mixture, or else aluminates may also be chosen. Preferably, alumina is used as matrix. Preferably, said matrix contains alumina in all its forms known to those skilled in the art, for instance aluminas of alpha, gamma, eta and delta type. Said aluminas differ notably in their specific surface area and their pore volume.

The shaped mixture of the matrix and of IZM-2 zeolite constitutes the support for the catalyst.

### Step i): Preparation of the Support

In accordance with the invention, the process comprises a step i) of preparing the support for the catalyst by shaping the IZM-2 zeolite with a matrix such that the weight percentage of zeolite is advantageously between 1% and 50% relative to the weight of the support, preferably between 2% and 30% and preferably between 5% and 20%.

### Shaping

The support for the catalyst used in the process according to the invention may advantageously be shaped via any technique known to those skilled in the art. The shaping can advantageously be carried out, for example, by extrusion, by pelleting, by the oil drop method, by rotating plate granulation or by any other method well known to those skilled in the art. The supports thus obtained may be in various shapes and sizes. Preferably, step i) is performed by blending-extrusion.

During the shaping of the support by blending and then extrusion, said IZM-2 zeolite may be introduced during the dissolution or suspension of the alumina compounds or alumina precursors, for instance boehmite. Said IZM-2 zeolite may be, for example, without this being limiting, in the form of a powder, a ground powder, a suspension, or a suspension which has undergone a deagglomeration treatment. Thus, for example, said zeolite may advantageously be placed in acidified or non-acidified suspension at a concentration adjusted to the final IZM-2 content targeted in the catalyst according to the invention. This suspension commonly referred to as a slip is then mixed with the alumina compounds or alumina precursors.

Moreover, the use of additives may advantageously be performed to facilitate the shaping and/or to improve the final mechanical properties of the supports, as is well known to those skilled in the art. Examples of additives that may notably be mentioned include cellulose, carboxymethylcellulose, carboxyethylcellulose, tall oil, xanthan gums, surfactants, flocculants such as polyacrylamides, carbon black, starches, stearic acid, polyacryl alcohol, polyvinyl alcohol, biopolymers, glucose, polyethylene glycols, etc.

Water may advantageously be added or removed to adjust the viscosity of the paste to be extruded. This step may advantageously be performed at any stage in the blending step.

To adjust the solids content of the paste to be extruded so as to make it extrudable, a compound that is predominantly solid, preferably an oxide or a hydrate, may also be added. A hydrate is preferably used, and even more preferably an aluminum hydrate. The loss on ignition of this hydrate is advantageously greater than 15%.

Extrusion of the paste derived from the blending step may advantageously be performed with any conventional commercially available tool. The paste derived from the blending is advantageously extruded through a die, for example using a piston or a single-screw or twin-screw extruder. The extrusion may advantageously be performed via any method known to those skilled in the art.

The catalyst supports prepared in step i) according to the invention are generally in the form of cylindrical extrudates or polylobal extrudates such as bilobal, trilobal or polylobal extrudates of straight or twisted form, but may optionally be manufactured and used in the form of crushed powders, tablets, rings, beads and/or wheels. Preferably, the catalyst supports according to the invention are in the form of spheres or extrudates. Advantageously, the support is in the form of extrudates with a diameter of between 0.5 and 5 mm and more particularly between 0.7 and 2.5 mm. The shapes may be cylindrical (which may or may not be hollow) and/or twisted and/or multilobal (for example 2, 3, 4 or 5 lobes) cylindrical and/or annular. The multilobal shape is advantageously preferably used.

### Drying

The support thus obtained on conclusion of the shaping step i) may then advantageously be subjected to a drying step. Said drying step is advantageously performed via any technique known to those skilled in the art.

Preferably, the drying is performed under a stream of air. Said drying may also be performed under a stream of any oxidizing, reducing or inert gas. Preferably, the drying is advantageously performed at a temperature of between 50° C. and 180° C., preferably between 60° C. and 150° C. and very preferably between 80° C. and 130° C.

### Calcination

Said support, optionally dried, then preferably undergoes a calcination step.

Said calcination step is advantageously performed in the presence of molecular oxygen, for example by flushing with air, at a temperature advantageously greater than 200° C. and less than or equal to 1100° C. Said calcination step may advantageously be performed in a traversed bed, in a swept bed or in a static atmosphere. For example, the oven used may be a rotary oven or may be a vertical oven with radial traversed layers. Preferably, said calcination step is performed for between more than one hour at 200° C. and less than one hour at 1100° C. For the shaped and optionally dried support, the calcination may advantageously be performed in the presence of water vapor and/or in the presence of an acidic or basic vapor. For example, the calcination may be performed under a partial pressure of ammonia.

### Post-Calcination Treatments

Post-calcination treatments may optionally be performed, so as to improve the properties of the calcined support, especially the textural properties.

Thus, the catalyst support used in the process according to the present invention may be subjected to a hydrothermal treatment in a confined atmosphere. The term “hydrothermal treatment in a confined atmosphere” means a treatment in an autoclave in the presence of water at a temperature above ambient temperature, preferably above 25° C., preferably above 30° C.

In the course of this hydrothermal treatment, the support may advantageously be impregnated, prior to its treatment in the autoclave (the autoclaving being done either in the vapor phase or in the liquid phase, this vapor or liquid phase of the autoclave possibly being acidic or not).

This impregnation, prior to autoclaving, may advantageously be acidic or not. This impregnation, prior to autoclaving, may advantageously be performed dry or by immersing the support in an acidic aqueous solution. The term “dry impregnation” means placing the support in contact with a volume of solution less than or equal to the total pore volume of the support. Preferably, the impregnation is carried out dry. The autoclave is preferably a rotating-basket autoclave such as the one defined in patent application EP 0 387 109 A. The temperature during the autoclaving may be between 100° C. and 250° C. for a period of time of between 30 minutes and 3 hours.

### Step ii): Deposition of the Hydrogenating-Dehydrogenating Function

In accordance with the invention, the deposition of the hydrogenating-dehydrogenating function is performed after the shaping step i).

In accordance with the invention, the process comprises a step ii) of depositing at least one noble metal from group VIII of the Periodic Table by impregnating the support prepared in step i), enabling a solid to be obtained, which has optionally undergone a drying and/or calcination and/or post-calcination treatment step, with an aqueous solution comprising at least the following compounds:
at least one ammoniacal compound chosen from the platinum(II) tetramine salts of formula Pt(NH₃)₄(OH)₂, Pt(NH₃)₄(NO₃)₂ or Pt(NH₃)₄X₂, the platinum(IV) hexamine salts of formula Pt(NH₃)₆X₄; the platinum(IV) halopentamine salts of formula (PtX(NH₃)₅)X₃; the platinum N-tetrahalodiamine salts of formula PtX₄(NH₃)₂; and the halogenated compounds of formula H(Pt(acac)₂X); the palladium(II) salts Pd(NH₃)₄SO₄ or Pd(NH₃)₄X₂, wherein X is a halogen chosen from chlorine, fluorine, bromine and iodine, X preferably being chlorine, and “acac” represents the acetylacetonate group (of empirical formula C₅H₇O₂), an acetylacetone-derived compound,

The hydrogenating-dehydrogenating function may advantageously be introduced before or after calcination of the support, preferably after.

In accordance with the invention, the support is impregnated with an aqueous solution. The impregnation of the support is preferably performed via the method of “dry” or “incipient wetness” impregnation or excess impregnation of a solution, which are well known to those skilled in the art. The impregnation may advantageously be performed in a single step with a solution containing all of the constituent elements of the final catalyst. Preferably, the “dry” or “incipient wetness” impregnation method is used.

Implementation of step ii) by impregnating the support with an aqueous solution comprising the specific ammoniacal metal salts as claimed allows the production of a bifunctional catalyst comprising an acid phase based on IZM-2 zeolite and a hydrogenating function based on group VIII noble metals wherein the group VIII metal is localized on the outer surface of the IZM-2 zeolite crystals and/or in the microporosity of the IZM-2 zeolite, i.e. in the IZM-2 zeolite crystals.

In accordance with the invention, the bifunctional catalyst prepared according to the invention comprises at least one group VIII noble metal chosen from platinum and palladium, alone or as a mixture, and very preferably platinum is chosen.

Preferably, step ii) consists of depositing at least one noble metal, preferably platinum, by impregnating the support prepared in step i) with an aqueous solution comprising ammoniacal compounds chosen from the platinum(II) tetramine salts of formula Pt(NH₃)₄(OH)₂, Pt(NH₃)₄(NO₃) or Pt(NH₃)₄X₂, the platinum(IV) hexamine salts of formula Pt(NH₃)₆X₄; the platinum(IV) halopentamine salts of formula (PtX(NH₃)₅)X₃; the platinum N-tetrahalodiamine salts of formula PtX₄(NH₃)₂; and the halogenated compounds of formula H(Pt(acac)₂X); X and “acac” having the aforementioned meaning, and preferably from platinum(II) tetramine salts of formula Pt(NH₃)₄(OH)₂, Pt(NH₃)₄(NO₃) or Pt(NH₃)₄X₂.

Preferably, said step ii) is performed so as to deposit on said support a content of noble metal and preferably of platinum of between 0.01% and 4% and preferably between 0.05% and 2%, and even more preferably between 0.05% and 1%, by weight relative to the total mass of said catalyst.

Preferably, the impregnation solution may also contain at least one ammonium salt not containing any noble metals, chosen from ammonium nitrate NH₄NO₃, ammonium chloride NH₄Cl, ammonium sulfate (NH₄)₂SO₄, ammonium hydroxide NH₄OH, ammonium bicarbonate NH₄HCO₃ and ammonium acetate NH₄H₃C₂O₂, alone or as a mixture, and preferably from ammonium nitrate NH₄NO₃, ammonium chloride NH₄Cl and ammonium acetate NH₄H₃C₂O₂, alone or as a mixture.

In the case where the impregnation solution also comprises an ammonium salt not containing noble metals, the concentrations of the various species in solution are such that the mole ratio between the ammonium salt not containing noble metals and the noble metal is between 0.1 and 400, preferably between 0.2 and 200 and very preferably between 0.3 and 150.

The platinum concentrations in the impregnation solution are adjusted so as to obtain the desired content of noble metal in the final catalyst.

The Castaing microprobe makes it possible to check whether an element, in the present case platinum, is homogeneously distributed in the catalyst via calculation of a distribution coefficient (cf. L. Sorbier, Determining the Distribution of Metal by Electron Probe Micro Analysis, in: H. Toulhoat, P. Raybaud (Eds.), Catalysis by Transition Metal Sulphides, Ed. Technip, Paris, 2013, p. 407-411 and references cited). The macroscopic distribution coefficient for platinum, obtained from its profile determined with a Castaing microprobe, defined as the ratio of the platinum concentrations at the core of the extrudate relative to at the edge of this same extrudate, is between 0.7 and 1.3 and preferably between 0.8 and 1.2. The value of this ratio, in the region of 1, is evidence of the homogeneity of distribution of the platinum in the catalyst.

The preferential localization of the noble metal from group VIII in the crystals and/or on the outer surface of the crystals of IZM-2 zeolite may also be demonstrated with a Castaing microprobe. A few extrudates are coated with resin (Struers, Ballerup) and then polished and metallized with carbon. The sample is then introduced into a Jeol JXA8100 machine to analyse at various points the local composition of silicon, aluminum and platinum. Starting with the local composition of aluminum and silicon, and knowing the silicon composition of the zeolite, the alumina/(IZM-2+alumina) mass ratio may be deduced for each point analyzed. The change in the local composition of platinum as a function of the alumina/(IZM-2+alumina) local mass ratio can thus be plotted and the preferential localization of platinum on the alumina or on the zeolite can be checked. When the local composition of platinum increases as the alumina/(IZM-2+alumina) local mass ratio increases, then the platinum is preferentially located on the alumina. When the local composition of platinum decreases as the alumina/(IZM-2+alumina) local mass ratio increases, then the platinum is preferentially located on the zeolite.

The dispersion of the noble metal(s) from group VIII, determined by chemisorption, for example by H₂/O₂ titration or by carbon monoxide chemisorption, is between 10% and 100%, preferably between 20% and 100% and even more preferably between 30% and 100%.

In one embodiment, the aqueous solution from step ii) or an aqueous solution different from that of step ii) may also comprise the precursors of the metals from groups IIIA, IVA and VIIB of the Periodic Table of the Elements, preferably chosen from gallium, indium, tin and rhenium and preferably chosen from indium, tin and rhenium. All the precursors of such metals may be suitable for use.

In the case where a solution different from that of step ii) is used, the depositions of the various elements are performed successively.

According to one variant, said precursors of said metals may be impregnated on the support derived from step i) separately from the precursors of the noble metals from group VIII.

When at least one metal from groups IIIA, IVA and VIIB is added separately, it is preferable for it to be added after the group VIII metal. In this case, a second optional step of impregnation of at least one aqueous solution comprising the precursors of the metals from groups IIIA, IVA and VIIB may advantageously be performed after step ii).

The additional metal chosen from the metals of groups IIIA, IVA and VIIB may be introduced by means of an aqueous solution comprising compounds chosen from chlorides, bromides and nitrates of the metals from groups IIIA, IVA and VIIB. For example, in the case of indium, the nitrate or the chloride is advantageously used, and, in the case of rhenium, perrhenic acid is advantageously used. The additional metal chosen from the metals of groups IIIA, IVA and VIIB may also be introduced via a solution comprising at least one organic compound chosen from the group constituted by complexes of said metal, and preferably polyketone complexes of the metal and hydrocarbylmetals chosen from alkyl, cycloalkyl, aryl, alkylaryl and arylalkyl metals. In the latter case, the introduction of the metal is advantageously performed using a solution of the organometallic compound of said metal in an organic solvent. Organohalogen compounds of the metal may also be used. Organic compounds of metals that may be mentioned in particular include tetrabutyltin, in the case of tin, and triphenylindium, in the case of indium.

If the additional metal chosen from the metals from groups IIIA, IVA and VIIB is introduced before the group VIII metal, the compound of the IIIA, IVA and/or VIIB metal used is generally chosen from the group constituted by the halide, nitrate, acetate, tartrate, carbonate and oxalate of the metal. The introduction is then advantageously performed in an aqueous solution comprising said compounds. However, it may also be introduced using a solution of an organometallic compound of the metal, for example tetrabutyltin. In this case, before introducing at least one group VIII metal, calcination in air will be performed.

In the case where several successive impregnation steps are performed, intermediate drying and/or calcination steps and/or a reduction step may advantageously be performed between the successive steps of impregnation with the various metals.

Preferably, the deposition(s) are performed so as to deposit on said support a content of metals from groups IIIA, IVA and VIIB of between 0.01% and 2% and preferably between 0.05% and 1% by weight relative to the total mass of said catalyst.

At least one drying step may advantageously be performed after the impregnation step(s), and preferably after step ii). Said drying step is advantageously performed via any technique known to those skilled in the art.

Preferably, the drying is performed under a stream of air. Said drying may also be performed under a stream of any oxidizing, reducing or inert gas. Preferably, the drying is advantageously performed at a temperature of between 50° C. and 180° C., preferably between 60° C. and 150° C. and very preferably between 80° C. and 130° C.

Step iii): Heat Treatment of the Solid Resulting from ii)

In accordance with the invention, said process comprises at least one heat treatment step iii) wherein the solid resulting from step ii) is brought into contact with at least one gas mixture containing oxygen, water, chlorine and/or at least one chlorinated compound, said heat treatment step being carried out at a temperature between 200° C. and 1100° C.

In accordance with the invention, at least one heat treatment step of the solid obtained in step ii) is carried out after step ii), and preferably after at least one drying step.

According to the invention, said heat treatment is carried out by bringing the solid resulting from step ii) into contact with a gas containing molecular oxygen, water and chlorine and/or at least one chlorinated compound, at a temperature above 200° C. and below or equal to 1100° C., preferably above 250° C. and below 800° C., more preferably above 300° C. and below 700° C., very preferably above 400° C. and below 600° C.

The weight content of oxygen in the gas during the heat treatment of step iii) is preferably between 10% and 50% by weight, and preferably between 15% and 35% by weight.

The weight content of water in the gas during the heat treatment of step iii) is preferably between 0.02% and 10% by weight and preferably between 0.02% and 5% by weight.

The weight content of chlorine and/or chlorinated compound in the gas during the heat treatment of step iii) is preferably between 0.02% and 5% by weight and preferably between 0.1% and 3% by weight.

The chlorinated compound can be an inorganic or organic chlorinated compound. The inorganic chlorinated compound is preferably hydrochloric acid (HCl). The organic chlorinated compound is preferably chosen from chloroalkanes and preferably from carbon tetrachloride, dichloropropane, dichloroethane and chloroform.

Preferably, the process can advantageously comprise, between step ii) and the heat treatment step iii), a step wherein the solid resulting from step ii) is brought into contact with a gas containing oxygen but free of chlorine and/or at least one chlorinated compound.

In this case, the solid resulting from step ii) is brought into contact with said gas containing oxygen but free of chlorine and/or at least one chlorinated compound until the desired temperature for the implementation of step iii) is reached, i.e. the temperature for the injection of water and chlorine and/or at least one chlorinated compound.

This temperature for injection of water and chlorine and/or at least one chlorinated compound is preferably above 200° C. and below or equal to 1100° C., preferably above 250° C. and below 800° C., more preferably above 300° C. and below 700° C., very preferably above 400° C. and below 600° C.

According to a first embodiment, at least one temperature hold can be implemented to reach the temperature for performing the heat treatment step iii).

According to a second embodiment, no temperature hold is implemented to reach the temperature for performing the heat treatment step iii).

According to the invention, the heat treatment step iii) is carried out in the presence of water.

Preferably, the water is introduced either with the gas containing oxygen but free of chlorine or chlorinated compound, or when the chlorine and/or chlorinated compound are introduced.

Preferably, the water is introduced when the chlorine and/or chlorinated compound are introduced.

Said heat treatment step iii) can advantageously be carried out in a traversed bed, in a swept bed or in a static atmosphere. For example, the oven used may be a rotary oven or may be a vertical oven with radial cross-flow layers.

The drop in temperature can then advantageously be carried out under a gas mixture comprising oxygen, optionally water vapor, and free of chlorine. The solid is advantageously cooled in contact with said gas mixture, preferably from a temperature below or equal to 400° C.

In a first preferred embodiment of the process, the solid resulting from step ii) is firstly brought into contact, at room temperature, with a first gas mixture containing oxygen, the weight content of oxygen in the gas being from 10% to 50% by weight, and preferably from 15% to 35% by weight. Said gas mixture is free of chlorine and/or chlorinated compound and its water content is less than 4% by weight. The heating in contact with the gas mixture is generally carried out gradually until the target temperature hold is reached. Typically the temperature increase rate is between 1° C. and 10° C. per minute. Several holds at various temperatures can be implemented when the first gas mixture is used before reaching the temperature for performing the heat treatment step iii). During said step iii) the solid is brought into contact with a second gas mixture containing oxygen, chlorine and/or at least one chlorinated compound and water. The second gas mixture advantageously consists of the first gas mixture into which water and chlorine and/or at least one chlorinated compound are continuously injected.

This temperature is preferably between 400° C. and 600° C. and the duration of this hold is preferably between 1 and 10 hours. The weight content of water in the second gas mixture is preferably between 0.02% and 10% by weight and even more advantageously between 0.02% and 5% by weight. The amount of chlorine and/or of chlorinated compound in the second gas mixture is preferably between 0.02% and 5% by weight, preferably between 0.1% and 3% by weight. The oxygen content in the second gas mixture is preferably between 10% and 50% by weight. Once the hold in contact with the second gas mixture is finished, the solid is then cooled in contact with said second gas mixture, preferably to a temperature below or equal to 400° C. The solid is then cooled in contact with a third gas mixture free of chlorine, and containing oxygen and optionally water vapor, preferably dry air, to room temperature. The third gas mixture preferably consists of the first gas mixture in which the continuous injection of water and chlorine and/or at least one chlorinated compound is eliminated.

In a second preferred embodiment of the process, the solid resulting from step ii) is firstly brought into contact, at room temperature, with a first gas mixture containing oxygen, the weight content of oxygen in the gas being from 10% to 50% by weight, and preferably from 15% to 35% by weight. Said gas mixture is free of chlorine and chlorinated compound and its weight content of water is less than 4% by weight. The heating in contact with the gas mixture is generally carried out gradually until the target temperature is reached. Unlike the first embodiment, no temperature hold is implemented when the first gas mixture is used to reach the temperature for performing the heat treatment step iii). Preferably, the temperature increase rate is between 1° C. and 10° C. per minute. The target temperature is preferably between 400° C. and 600° C. Once the desired temperature is reached, the solid is brought into contact with a second gas mixture containing oxygen, chlorine and/or a chlorinated compound and water. The second gas mixture preferably consists of the first gas mixture into which water and chlorine and/or at least one chlorinated compound are continuously injected.

This temperature is preferably between 400° C. and 600° C. and the duration of this hold is preferably between 1 and 10 hours. The weight content of water in the second gas mixture is preferably between 0.02% and 10% by weight and even more advantageously between 0.02% and 5% by weight. The weight content of chlorine and/or of chlorinated compound in the second gas mixture is preferably between 0.02% and 5% by weight, preferably between 0.1% and 3% by weight. The weight content of oxygen in the second gas mixture is preferably between 10% and 50% by weight. Once the hold in contact with the second gas mixture is finished, the solid is then cooled in contact with said second gas mixture, preferably to a temperature below or equal to 400° C. The solid is then cooled in contact with a third gas mixture free of chlorine, and containing oxygen and optionally water vapor, preferably dry air, to room temperature. The third gas mixture preferably consists of the first gas mixture in which the continuous injection of water and chlorine and/or at least one chlorinated compound is suppressed.

Before its use in the isomerization process according to the invention, the catalyst obtained on conclusion of the preparation process according to the invention is preferably subjected to a reduction step. This reduction step is advantageously performed by treatment under hydrogen at a temperature of between 150° C. and 650° C. at a total pressure of between 0.1 and 25 MPa. For example, a reduction consists of a hold at 150° C. for two hours and then a temperature increase up to 450° C. at a rate of 1° C./minute, and then a hold of two hours at 450° C.; throughout this reduction step, the hydrogen flow rate is 1000 normal m³ of hydrogen per tonne of catalyst and the total pressure is kept constant at 0.2 MPa. Any ex situ reduction method may advantageously be envisaged. Prior reduction of the final catalyst ex situ, under a stream of hydrogen, may be performed, for example at a temperature of from 450° C. to 600° C., for a time of from 0.5 to 4 hours.

Said catalyst also advantageously comprises sulfur. In the case where the catalyst of the invention contains sulfur, said sulfur may be introduced at any step in the preparation of the catalyst or alternatively by in situ and/or ex situ sulfurization before the catalytic reaction. In the case of in situsulfurization, the reduction, if the catalyst has not been reduced beforehand, takes place before the sulfurization. In the case of ex situ sulfurization, the reduction is also performed, followed by sulfurization. The sulfurization is preferably performed in the presence of hydrogen using any sulfurizing agent that is well known to those skilled in the art, for instance dimethyl sulfide or hydrogen sulfide.

The catalysts according to the invention are in various shapes and sizes. They are generally used in the form of cylindrical extrudates and/or polylobal extrudates such as bilobal, trilobal or polylobal extrudates of straight and/or twisted form, but may optionally be manufactured and used in the form of crushed powders, tablets, rings, beads and/or wheels. Preferably, the catalysts used in the process according to the invention are in the form of spheres or extrudates. Advantageously, the catalyst is in the form of extrudates with a diameter of between 0.5 and 5 mm and more particularly between 0.7 and 2.5 mm. The shapes may be cylindrical (which may or may not be hollow) and/or twisted and/or multilobal (for example 2, 3, 4 or 5 lobes) cylindrical and/or annular. The multilobal shape is advantageously preferably used. The metal deposition does not change the shape of the support.

The preparation process according to the invention therefore makes it possible to obtain a bifunctional catalyst comprising an acid phase based on IZM-2 zeolite and a hydrogenating function based on group VIII noble metals.

Another subject of the invention relates to the catalyst comprising an acid function constituted by IZM-2 zeolite, a hydrogenating function comprising at least one noble metal from group VIII of the Periodic Table chosen from platinum and palladium, and a matrix, obtained via the process according to the invention.

In the catalyst obtained according to the process of the invention, the group VIII metal is preferentially localized in the crystals and/or at the surface of the crystals of the IZM-2 zeolite and the group VIII metal is uniformly distributed on said catalyst.

Said catalyst prepared according to the invention may advantageously comprise at least one additional metal chosen from the group formed by metals from groups IIIA, IVA and VIIB of the Periodic Table of the Elements, preferably chosen from gallium, indium, tin and rhenium. Said additional metal is preferably chosen from indium, tin and rhenium.

Said catalyst also advantageously comprises sulfur.

Said catalyst prepared according to the invention more particularly comprises, and preferably is constituted of:
from 1% to 50% by weight, preferably from 2% to 30% by weight and even more preferably from 5% to 20% by weight of IZM-2 zeolite according to the invention,
from 0.01% to 4%, preferably from 0.05% to 2% by weight and even more preferably from 0.05% to 1% by weight, relative to the total mass of said catalyst, of at least one metal from group VIII of the Periodic Table of the Elements, preferably platinum,
optionally from 0.01% to 2% and preferably from 0.05% to 1% by weight of at least one additional metal chosen from the group formed by metals from groups IIIA, IVA and VIIB,
optionally a sulfur content, preferably such that the ratio of the number of moles of sulfur to the number of moles of the group VIII metal(s) is between 0.3 and 20,
at least one matrix, preferably alumina, providing the remainder to 100% in the catalyst.

### The Isomerization Process

A subject of the present invention is also a process for the isomerization of a paraffinic feedstock, said process comprising placing said paraffinic feedstock in contact with at least said catalyst according to the invention present in a catalytic reactor.

In accordance with the invention, said paraffinic feedstock used in the process according to the invention is produced from renewable resources.

The paraffins of said paraffinic feedstock contain between 9 and 25, preferably between 10 and 25 and very preferably between 10 and 22 carbon atoms. The paraffin content in said feedstock used in the process according to the invention is advantageously greater than 90% by weight, preferably greater than 95% by weight and even more preferably greater than 98% by weight. Within said paraffins, the mass percentage of isoparaffins is less than 15%, preferably less than 10% and very preferably less than 5%.

Preferably, said paraffinic feedstock is produced from renewable resources chosen from plant oils, algae oils or algal oils, fish oils and fats of plant or animal origin, or mixtures of such feedstocks.

Said plant oils can advantageously be totally or partly crude or refined, and result from plants chosen from rape, sunflower, soybean, palm, olive, coconut, copra, castor oil plant, cotton plant, peanut oil, linseed oil and sea kale oil, and all the oils resulting, for example, from sunflower or rape by genetic modification or hybridization, this list not being limiting. Said animal fats are advantageously chosen from blubber and fats composed of residues from the food industry or resulting from the catering industries. Frying oils, various animal oils, such as fish oils, tallow or lard, can also be used.

The renewable resources from which the paraffinic feedstock used in the process according to the invention is produced essentially contain chemical structures of triglyceride type which a person skilled in the art also knows by the name fatty acid triester, and also free fatty acids, the fatty chains of which contain between 9 and 25 carbon atoms.

The hydrocarbon chain length and structure of these fatty acids is compatible with the hydrocarbons present in gas oil and kerosene, i.e. the middle distillate fraction. A fatty acid triester is thus composed of three fatty acid chains. These fatty acid chains, in triester form or in free fatty acid form, have a number of unsaturations per chain, also known as the number of carbon-carbon double bonds per chain, generally between 0 and 3, but which may be higher notably for oils derived from algae which generally contain from 5 to 6 unsaturations per chain.

The molecules present in said renewable resources used in the present invention thus have a number of unsaturations, expressed per triglyceride molecule, advantageously between 0 and 18. In these feedstocks, the degree of unsaturation, expressed as the number of unsaturations per hydrocarbon fatty chain, is advantageously between 0 and 6.

The renewable resources generally also include various impurities and notably heteroatoms such as nitrogen. The nitrogen contents in plant oils are generally between 1 ppm and 100 ppm by weight approximately, depending on their nature. They may be up to 1% by weight for particular feedstocks.

Said paraffinic feedstock used in the process according to the invention is advantageously produced from renewable resources according to processes known to those skilled in the art. One possible method is catalytic transformation of said renewable resources into deoxygenated paraffinic effluent in the presence of hydrogen, and in particular hydrotreatment.

Preferably, said paraffinic feedstock is produced by hydrotreatment of said renewable resources. These processes for the hydrotreatment of renewable resources are already well known and are described in numerous patents. By way of example, said paraffinic feedstock used in the process according to the invention may advantageously be produced, preferably by hydrotreatment and then by gas/liquid separation, from said renewable resources as in patent FR 2 910 483 or in patent FR 2 950 895.

Said paraffinic feedstock used in the process according to the invention may also be a paraffinic feedstock produced via a process involving a step of upgrading via the Fischer-Tropsch route. In the Fischer-Tropsch process, synthesis gas (CO+H₂) is converted catalytically into oxygenated products and into essentially linear hydrocarbons in gaseous, liquid or solid form. Said products obtained constitute the feedstock of the process according to the invention. Synthesis gas (CO+H₂) is advantageously produced from natural gas, coal, biomass, any source of hydrocarbon-based compounds or a mixture of these sources. Thus, the paraffinic feedstocks obtained, according to a Fischer-Tropsch synthesis process, from a synthesis gas (CO+H₂) produced from renewable resources, natural gas or coal may be used in the process according to the invention. Preferably, said paraffinic feedstock produced by Fischer-Tropsch synthesis and used in the process according to the invention predominantly comprises n-paraffins. Thus, said feedstock comprises a content of n-paraffins of greater than 60% by weight relative to the total mass of said feedstock. Said feedstock may also comprise a content of oxygenated products preferably of less than 10% by weight, a content of unsaturated substances, that is to say preferably olefinic products, preferably of less than 20% by weight, and a content of isoparaffins preferably of less than 10% by weight relative to the total mass of said feedstock.

Very preferably, said feedstock comprises a content of n-paraffins of greater than 70% by weight and even more preferably greater than 80% by weight relative to the total mass of said feedstock. The paraffins of said paraffinic feedstock contain between 9 and 25, preferably between 10 and 25 and very preferably between 10 and 22 carbon atoms.

Preferably, said paraffinic feedstock produced by Fischer-Tropsch synthesis is free of heteroatomic impurities, for instance sulfur, nitrogen or metals.

Said isomerization process is generally performed according to the following operating conditions:
a temperature of from 200° C. to 500° C., preferably from 210° C. to 450° C. and even more preferably from 220° C. to 430° C.;
a partial pressure of hydrogen of from 0.3 to 5.5 MPa, preferably from 0.4 to 4.8 MPa;
a total pressure of from 0.45 to 7 MPa, preferably from 0.6 to 6 MPa; and
a feed space velocity, expressed in kg of feedstock introduced per kilogram of catalyst and per hour, of from 0.25 to 30 h⁻¹, preferably from 1 to 10 h⁻¹ and more preferably from 2 to 6 h⁻¹.

### BRIEF DESCRIPTION OF THE DRAWINGS

FIG. 1 represents the change in the local weight percentage of platinum as a function of the local weight % Al₂O₃/(weight % Al₂O₃+weight % IZM-2) ratio obtained by Castaing microprobe for catalyst A not in accordance with the invention.

FIG. 2 represents the change in the local weight percentage of platinum as a function of the local weight % Al₂O₃/(weight % Al₂O₃+weight % IZM-2) ratio obtained by Castaing microprobe for catalyst B in accordance with the invention.

FIG. 3 represents the change in the local weight percentage of platinum as a function of the local weight % Al₂O₃/(weight % Al₂O₃+weight % IZM-2) ratio obtained by Castaing microprobe for catalyst C not in accordance with the invention.

FIG. 4 represents the change in the local weight percentage of platinum as a function of the local weight % Al₂O₃/(weight % Al₂O₃+weight % IZM-2) ratio obtained by Castaing microprobe for catalyst D not in accordance with the invention.

FIG. 5 represents the change in the local weight percentage of platinum as a function of the local weight % Al₂O₃/(weight % Al₂O₃+weight % IZM-2) ratio obtained by Castaing microprobe for catalyst E in accordance with the invention.

FIG. 6 represents the change in the local weight percentage of platinum as a function of the local weight % Al₂O₃/(weight % Al₂O₃+weight % IZM-2) ratio obtained by Castaing microprobe for catalyst F not in accordance with the invention.

FIG. 7 represents the change in the local weight percentage of platinum as a function of the local weight % Al₂O₃/(weight % Al₂O₃+weight % IZM-2) ratio obtained by Castaing microprobe for catalyst G not in accordance with the invention.

The following examples illustrate the invention without, however, limiting the scope thereof.

### EXAMPLES

### Example 1 (not in Accordance with the Invention): Preparation of the Isomerization Catalyst a

### Synthesis of the IZM-2 Zeolite

The IZM-2 zeolite was synthesized in accordance with the teaching of patent FR 2 918 050 B. A colloidal silica suspension known under the trade name Ludox HS-40, sold by Aldrich, is incorporated into a solution composed of sodium hydroxide (Prolabo), 1,6-bis(methylpiperidinium)hexane dibromide structuring agent, aluminum hydroxide (Aldrich) and deionized water. The molar composition of the mixture is as follows: 1 SiO₂; 0.0042 Al₂O₃; 0.1666 Na₂O; 0.1666 1,6-bis(methylpiperidinium)hexane; 33.3333 H₂O. The mixture is stirred vigorously for 30 minutes. The mixture is then transferred, after homogenization, into a Parr autoclave. The autoclave is heated for 5 days at 170° C. with spindle stirring (30 rpm). The product obtained is filtered, washed with deionized water to reach neutral pH and then dried overnight at 100° C. in an oven. The solid is then introduced into a muffle furnace and calcined therein so as to remove the structuring agent. The calcination cycle comprises a temperature increase up to 200° C., a hold of two hours at this temperature, a temperature increase up to 550° C., followed by a hold of eight hours at this temperature and finally a return to ambient temperature. The temperature rises are performed at a rate of 2° C./minute. The solid thus obtained is then refluxed for 2 hours in an aqueous ammonium nitrate solution (10 ml of solution per gram of solid, ammonium nitrate concentration of 3M) so as to exchange the sodium alkaline cations with ammonium ions. This refluxing step is performed four times with fresh ammonium nitrate solution, and the solid is then filtered off, washed with deionized water and dried in an oven overnight at 100° C. Finally, to obtain the zeolite in its acid (protonated H⁺) form, a step of calcination is performed at 550° C. for 10 hours (temperature increase rate of 2° C./minute) in a traversed bed under dry air (2 normal liters per hour and per gram of solid). The solid thus obtained was analysed by X-ray diffraction and identified as consisting of IZM-2 zeolite.

### Preparation of the IZM-2/Alumina Support (Step i))

The IZM-2/alumina support is obtained by blending and extrusion of the IZM-2 zeolite with an alumina gel supplied by the company Axens. The blended paste is extruded through a quadrilobal die 1.5 mm in diameter. After drying in an oven overnight at 110° C., the extrudates are calcined at 520° C. for two hours (temperature increase rate of 5° C./minute) in a traversed bed under dry air (2 normal litres per hour and per gram of solid). The weight content of IZM-2 zeolite on the support after calcination is 13% by weight.

Platinum Deposition (Step ii), in Accordance with the Invention)

The deposition is carried out by dry impregnation of the IZM-2/alumina support prepared in step i) with an aqueous solution containing platinum tetramine nitrate Pt(NH₃)₄(NO₃)₂. 20 g of support are typically used, and are dry-impregnated in a pan. After impregnation, the solid is left to mature for at least five hours in the laboratory air and is then dried overnight in a ventilated oven at 110° C.

Heat Treatment of the Solid from ii) (Step iii), not in Accordance with the Invention)

After drying, the solid is then calcined in a traversed bed under a flow of dry air (1 normal liter per hour and per gram of solid), the weight content of oxygen in the gas being 23% by weight, the first gas mixture being free of chlorine and containing a water content of less than 0.001% by weight in a tube furnace under the following conditions:
temperature increase from ambient temperature to 150° C. at 5° C./min;
hold of 1 hour at 150° C.;
increase from 150° C. to 450° C. at 5° C./min;
hold of 1 hour at 450° C.;
decrease to ambient temperature.

On conclusion of step iii), various characterizations are carried out on catalyst A. The Pt content measured by XRF is 0.34% by weight, and its distribution coefficient measured by Castaing microprobe is 1.03.

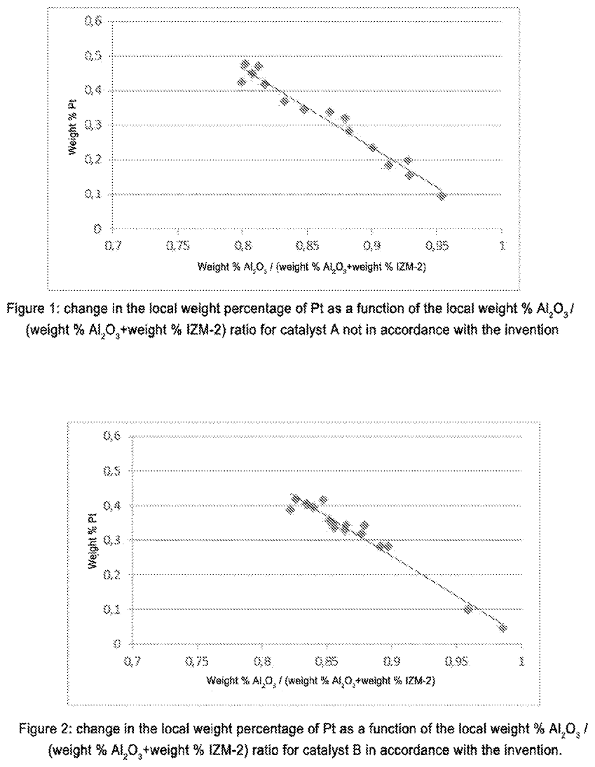

FIG. 1 represents the change in the local weight percentage of platinum as a function of the local weight % Al₂O₃/(weight % Al₂O₃+weight % IZM-2) ratio obtained by Castaing microprobe. Locally, the weight percentage of Pt decreases as the amount of alumina increases relative to the amount of IZM-2, which reflects preferential deposition of the platinum on the IZM-2 zeolite. It is thus observed that, for weight % Al₂O₃/(weight % Al₂O₃+weight % IZM-2) ratios which tend toward 1, i.e. for analysed zones not containing any IZM-2 zeolite, the weight % of platinum tends toward a zero value.

### Example 2 (in Accordance with the Invention): Preparation of the Isomerization Catalyst B

### Synthesis of IZM-2 Zeolite

This is the same zeolite as the one described in example 1.

### Preparation of the IZM-2/Alumina Support (Step i))

This is the same support as the one described in example 1.

Platinum Deposition (Step ii), in Accordance with the Invention)

This is the same deposition as the one described in example 1.

Heat Treatment of the Solid from ii) (Step iii), in Accordance with the Invention)

After drying, the catalyst then undergoes a heat treatment by bringing said catalyst into contact, at ambient temperature, in a tube furnace, with a first gas mixture constituted of dry air, the weight content of oxygen in the gas being 23% by weight, the first gas mixture being free of chlorine and containing a water content of less than 0.001% by weight, under the following conditions:
temperature increase from ambient temperature to 150° C. at 5° C./min under a flow of dry air (1 normal liter per hour and per gram of solid);
hold of 1 hour at 150° C. under a flow of dry air (1 normal liter per hour and per gram of solid);
increase from 150° C. to 450° C. at 5° C./min under a flow of dry air (1 normal liter per hour and per gram of solid);
hold of 1 hour at 450° C. under a flow of dry air (1 normal liter per hour and per gram of solid);
increase from 450° C. to 520° C. at 5° C./min under a flow of dry air (3.3 normal liters per hour and per gram of solid);

At the start of the hold at 520° C., water and dichloropropane are continuously injected into the first gas mixture to form the second gas mixture. The amounts injected correspond to a weight content of water of 2% by weight and of dichloropropane of 0.63% by weight in the gas mixture. The temperature hold at 520° C. is maintained for four hours. The temperature is then decreased from 520° C. to 400° C. at 5° C./min, still under the second gas mixture. At 400° C., the injection of water and dichloropropane is cut and the solid is cooled to ambient temperature under a flow of dry air (3.3 normal liters per hour and per gram of solid).

On conclusion of step iii), various characterizations are carried out on catalyst B. The Pt content measured by XRF is 0.34% by weight, and its distribution coefficient measured by Castaing microprobe is 1.03.

FIG. 2 represents the change in the local weight percentage of platinum as a function of the local weight % Al₂O₃/(weight % Al₂O₃+weight % IZM-2) ratio obtained by Castaing microprobe.

As for catalyst A, it is noted that, locally, the weight percentage of Pt decreases as the amount of alumina increases relative to the amount of IZM-2, which reflects preferential deposition of the platinum on the IZM-2 zeolite.

### Example 3 (not in Accordance with the Invention): Preparation of the Isomerization Catalyst C

### Synthesis of the IZM-2 Zeolite

This is the same zeolite as the one described in example 1.

### Preparation of the IZM-2/Alumina Support (Step i))

The IZM-2/alumina support is obtained by blending and extrusion of the IZM-2 zeolite with an alumina gel supplied by the company Axens. The blended paste is extruded through a quadrilobal die 1.5 mm in diameter. After drying in an oven overnight at 110° C., the extrudates are calcined at 550° C. for two hours (temperature increase rate of 5° C./minute) in a traversed bed under dry air (2 normal litres per hour and per gram of solid). The weight content of IZM-2 zeolite on the support after calcination is 13% by weight.

Platinum Deposition (Step ii), in Accordance with the Invention)

The deposition is carried out by dry impregnation of the IZM-2/alumina support prepared in step i) with an aqueous solution containing platinum tetramine nitrate Pt(NH₃)₄(NO₃)₂. 20 g of support are typically used, and are dry-impregnated in a pan. After impregnation, the solid is left to mature for at least five hours in the laboratory air and is then dried overnight in a ventilated oven at 110° C.

Heat Treatment of the Solid from ii) (Step iii), not in Accordance with the Invention)

After drying, the solid is then calcined in a traversed bed under a flow of dry air (1 normal liter per hour and per gram of solid), the weight content of oxygen in the gas being 23% by weight, said dry air being free of chlorine and containing a water content of less than 0.001% by weight in a tube furnace under the following conditions:
temperature increase from ambient temperature to 150° C. at 5° C./min;
hold of 1 hour at 150° C.;
increase from 150° C. to 450° C. at 5° C./min;
hold of 1 hour at 450° C.;
decrease to ambient temperature.

On conclusion of step iii), various characterizations are carried out on catalyst C. The Pt content measured by XRF is 0.26% by weight, and its distribution coefficient measured by Castaing microprobe is 1.00.

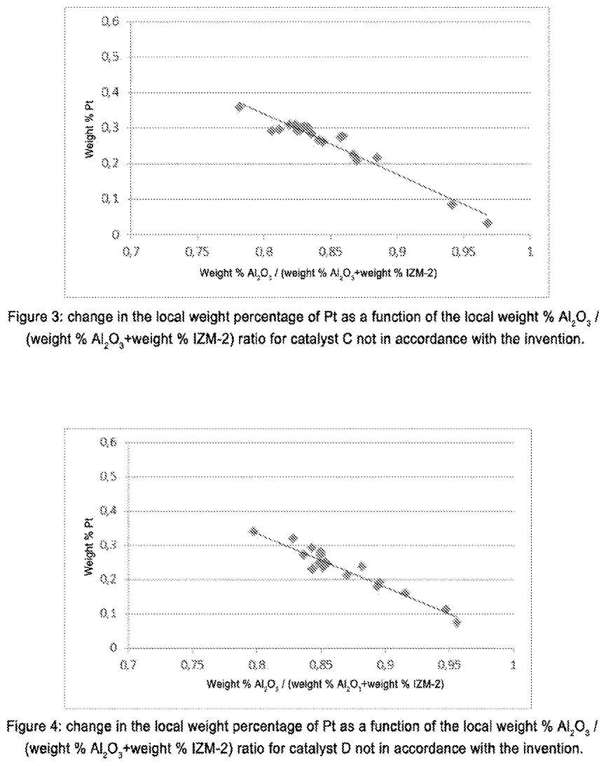

FIG. 3 represents the change in the local weight percentage of platinum as a function of the local weight % Al₂O₃/(weight % Al₂O₃+weight % IZM-2) ratio obtained by Castaing microprobe. Locally, the weight percentage of Pt decreases as the amount of alumina increases relative to the amount of IZM-2, which reflects preferential deposition of the platinum on the IZM-2 zeolite.

It is thus observed that, for weight % Al₂O₃/(weight % Al₂O₃+weight % IZM-2) ratios which tend toward 1, i.e. for analysed zones not containing any IZM-2 zeolite, the weight % of platinum tends toward a zero value.

### Example 4 (in Accordance with the Invention): Preparation of the Isomerization Catalyst D

### Synthesis of the IZM-2 Zeolite

This is the same zeolite as the one described in example 1.

### Preparation of the IZM-2/Alumina Support (Step i))

This is the same support as the one described in example 3.

Platinum Deposition (Step ii), in Accordance with the Invention)

This is the same deposition as the one described in example 3.

Heat Treatment of the Solid from ii) (Step iii), in Accordance with the Invention)

After drying, the catalyst then undergoes a heat treatment by bringing said catalyst into contact, at ambient temperature, in a tube furnace, with a first gas mixture of dry air, the weight content of oxygen in the gas being 23% by weight, the first gas mixture being free of chlorine and containing a water content of less than 0.001% by weight, under the following conditions:
temperature increase from ambient temperature to 150° C. at 5° C./min under a flow of dry air (1 normal liter per hour and per gram of solid);
hold of 1 hour at 150° C. under a flow of dry air (1 normal liter per hour and per gram of solid);
increase from 150° C. to 450° C. at 5° C./min under a flow of dry air (1 normal liter per hour and per gram of solid);
hold of 1 hour at 450° C. under a flow of dry air (1 normal liter per hour and per gram of solid);
increase from 450° C. to 520° C. at 5° C./min under a flow of dry air (3.3 normal liters per hour and per gram of solid);

At the start of the hold at 520° C., water and dichloropropane are continuously injected into the first gas mixture to form the second gas mixture. The amounts injected correspond to a weight content of water of 2% by weight and of dichloropropane of 0.63% by weight in the gas mixture. The temperature hold at 520° C. is maintained for four hours. The temperature is then decreased from 520° C. to 400° C. at 5° C./min, still under the second gas mixture. At 400° C., the injection of water and dichloropropane is cut and the solid is cooled to ambient temperature under a flow of dry air (3.3 normal liters per hour and per gram of solid).

On conclusion of step iii), various characterizations are carried out on catalyst D. The Pt content measured by XRF is 0.25% by weight, and its distribution coefficient measured by Castaing microprobe is 0.99.

FIG. 4 represents the change in the local weight percentage of platinum as a function of the local weight % Al₂O₃/(weight % Al₂O₃+weight % IZM-2) ratio obtained by Castaing microprobe. As for catalyst A, it is noted that, locally, the weight percentage of Pt decreases as the amount of alumina increases relative to the amount of IZM-2, which reflects preferential deposition of the platinum on the IZM-2 zeolite. It is thus observed that, for weight % Al₂O₃/(weight % Al₂O₃+weight % IZM-2) ratios which tend toward 1, i.e. for analysed zones not containing any IZM-2 zeolite, the weight % of platinum tends toward a zero value.

### Example 5 (in Accordance with the Invention): Preparation of the Isomerization Catalyst E

### Synthesis of the IZM-2 Zeolite

This is the same zeolite as the one described in example 1.

### Preparation of the IZM-2/Alumina Support (Step i))

This is the same support as the one described in example 3.

Platinum Deposition (Step ii), in Accordance with the Invention)

This is the same deposition as the one described in example 3.

Heat Treatment of the Solid from ii) (Step iii), in Accordance with the Invention)

After drying, the catalyst then undergoes a heat treatment by bringing said catalyst into contact, at ambient temperature, in a tube furnace, with a first gas mixture of dry air (3.3 normal liters per hour and per gram of solid), the weight content of oxygen in the gas being 23% by weight, the first gas mixture being free of chlorine and containing a water content of less than 0.001% by weight. The temperature is increased from ambient temperature to 520° C. at 5° C./min.

At the start of the hold at 520° C., in addition to the flow of the first gas mixture of dry air, water and dichloropropane are continuously injected in order to form a second gas mixture. The amounts injected correspond to a weight content of water of 2% by weight and of dichloropropane of 0.63% by weight in the gaseous effluent. The temperature hold at 520° C. is maintained for four hours. The temperature is then decreased from 520° C. to 400° C. at 5° C./min, still under the second gas mixture. At 400° C., the injection of water and dichloropropane is cut and the solid is cooled to ambient temperature under a flow of dry air (3.3 normal liters per hour and per gram of solid).

On conclusion of step iii), various characterizations are carried out on catalyst E. The Pt content measured by XRF is 0.25% by weight, and its distribution coefficient measured by Castaing microprobe is 1.00.

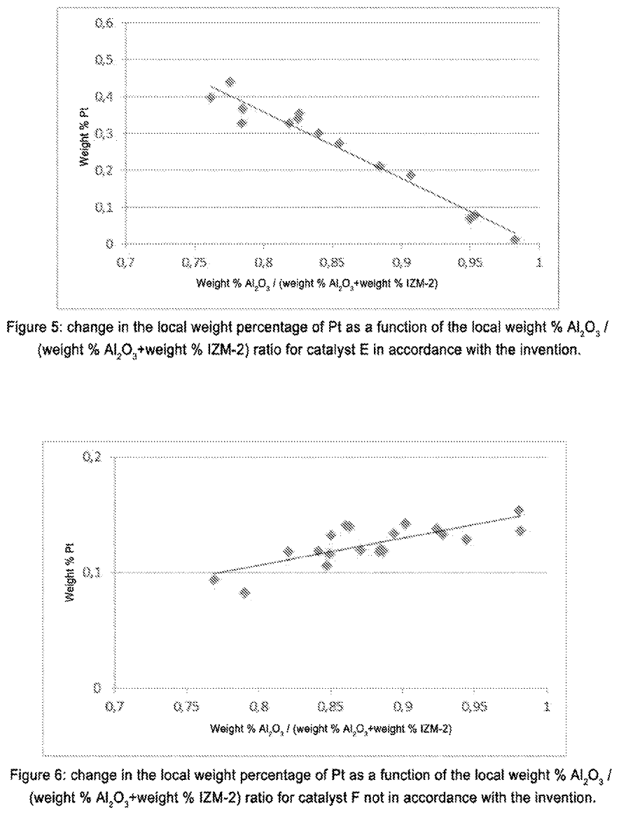

FIG. 5 represents the change in the local weight percentage of platinum as a function of the local weight % Al₂O₃/(weight % Al₂O₃+weight % IZM-2) ratio obtained by Castaing microprobe. As for catalyst A, it is noted that, locally, the weight percentage of Pt decreases as the amount of alumina increases relative to the amount of IZM-2, which reflects preferential deposition of the platinum on the IZM-2 zeolite. It is thus observed that, for weight % Al₂O₃/(weight % Al₂O₃+weight % IZM-2) ratios which tend toward 1, i.e. for analysed zones not containing any IZM-2 zeolite, the weight % of platinum tends toward a zero value.

### Example 6 (not in Accordance with the Invention): Preparation of the Isomerization Catalyst F

### Synthesis of the IZM-2 Zeolite

This is the same zeolite as the one described in example 1.

### Preparation of the IZM-2/Alumina Support (Step i))

This is the same support as the one described in example 3.

Platinum Deposition (Step ii). Not in Accordance with the Invention)

Catalyst F is prepared by excess impregnation of the IZM-2/alumina support with an aqueous solution containing hexachloroplatinic acid, a platinum precursor not in accordance with the invention. The concentration of hexachloroplatinic acid in the solution is 1.28×10⁻³ mol/l.

20 g of support are used, the pore volume of which is filled with distilled water and the solid is left to mature for one hour at ambient temperature. The solid is then immersed in 80 ml of a hydrochloric acid HCl solution of concentration 3.52×10⁻¹ mol/I in an Erlenmeyer flask, and the whole is then stirred on a stirring table (100 rpm) at ambient temperature for one hour. The hydrochloric acid solution is then removed and the solid is immersed in 80 ml of the hexachloroplatinic acid solution described previously, and the whole is then stirred on a shaker (100 rpm) at ambient temperature for 24 hours. The impregnation solution is then removed and the solid is rinsed with 160 ml of distilled water. The solid is then dried in a ventilated oven overnight at 110° C.

Heat Treatment of the Solid from ii) (Step iii), not in Accordance with the Invention)

After drying, the solid is then calcined in a traversed bed under a flow of dry air (1 normal liter per hour and per gram of solid), the weight content of oxygen in the gas being 23% by weight, said dry air being free of chlorine and containing a water content of less than 0.001% by weight in a tube furnace under the following conditions:
temperature increase from ambient temperature to 150° C. at 5° C./min;
hold of 1 hour at 150° C.;
increase from 150° C. to 450° C. at 5° C./min;
hold of 1 hour at 450° C.;
decrease to ambient temperature.

On conclusion of step iii), various characterizations are carried out on catalyst F. The Pt content measured by XRF is 0.11% by weight, and its distribution coefficient measured by Castaing microprobe is 1.01.

FIG. 6 represents the change in the local weight percentage of platinum as a function of the local weight % Al₂O₃/(weight % Al₂O₃+weight % IZM-2) ratio obtained by Castaing microprobe.

In contrast with catalysts A, B, C, D and E, it is noted that, locally, the weight percentage of Pt tends to increase as the amount of alumina increases relative to the amount of IZM-2, which reflects preferential deposition of the platinum on the alumina.

### Example 7 (not in Accordance with the Invention): Preparation of the Isomerization Catalyst G

### Synthesis of the IZM-2 Zeolite

This is the same zeolite as the one described in example 1.

### Preparation of the IZM-2/Alumina Support (Step i))

This is the same support as the one described in example 6.

Platinum Deposition (Step ii), not in Accordance with the Invention)

This is the same deposition is the one described in example 6 with the platinum precursor not in accordance with the invention.

Heat Treatment of the Solid from ii) (Step iii), in Accordance with the Invention)

After drying, the catalyst then undergoes a heat treatment by bringing said catalyst into contact, at ambient temperature, in a tube furnace, with a first gas mixture of dry air, the weight content of oxygen in the gas being 23% by weight, the first gas mixture being free of chlorine and containing a water content of less than 0.001% by weight, under the following conditions:
temperature increase from ambient temperature to 150° C. at 5° C./min under a flow of dry air (1 normal liter per hour and per gram of solid);
hold of 1 hour at 150° C. under a flow of dry air (1 normal liter per hour and per gram of solid);
increase from 150° C. to 450° C. at 5° C./min under a flow of dry air (1 normal liter per hour and per gram of solid);
hold of 1 hour at 450° C. under a flow of dry air (1 normal liter per hour and per gram of solid);
increase from 450° C. to 520° C. at 5° C./min under a flow of dry air (3.3 normal liters per hour and per gram of solid);

At the start of the hold at 520° C., in addition to the flow of the first gas mixture of dry air, water and dichloropropane are continuously injected to form the second gas mixture. The amounts injected correspond to a weight content of water of 2% by weight and of dichloropropane of 0.63% by weight in the gaseous effluent. The temperature hold at 520° C. is maintained for four hours. The temperature is then decreased from 520° C. to 400° C. at 5° C./min, still under the second gas mixture. At 400° C., the injection of water and dichloropropane is cut and the solid is cooled to ambient temperature under a flow of dry air (3.3 normal liters per hour and per gram of solid).

On conclusion of step iii), various characterizations are carried out on catalyst G. The Pt content measured by XRF is 0.10% by weight, and its distribution coefficient measured by Castaing microprobe is 1.04.

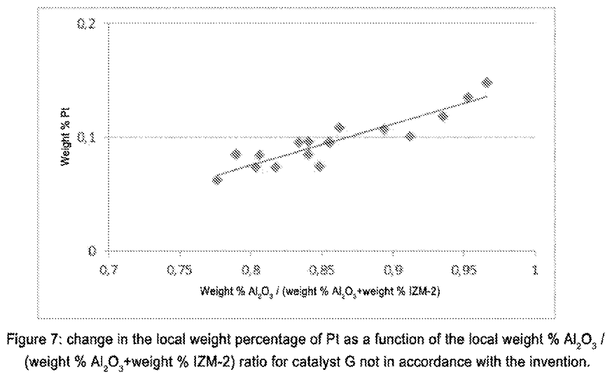

FIG. 7 represents the change in the local weight percentage of platinum as a function of the local weight % Al₂O₃/(weight % Al₂O₃+weight % IZM-2) ratio obtained by Castaing microprobe.

In contrast with catalysts A, B, C, D and E, it is noted that, locally, the weight percentage of Pt tends to increase as the amount of alumina increases relative to the amount of IZM-2, which reflects preferential deposition of the platinum on the alumina.

### Example 8: Evaluation of the Catalytic Properties of the Catalysts in Isomerization of a Paraffinic Feedstock

The catalysts were tested in the isomerization of a paraffinic feedstock composed of n-hexadecane. The tests were performed in a micro-unit using a fixed-bed reactor and working in downflow without recycling. The analysis of the hydrocarbon-based effluents is performed online by gas chromatography. Once charged into the unit, the catalyst undergoes a first step of drying under nitrogen under the following conditions:
nitrogen flow rate: 2 normal liters per hour and per gram of catalyst,
total pressure: 0.1 MPa,
temperature increase rate from ambient temperature to 150° C.: 5° C./min,
hold at 150° C. for 30 minutes.

After drying, the nitrogen is replaced with hydrogen and a step of reduction under a flow of pure hydrogen is then performed under the following conditions:
hydrogen flow rate: 5 normal liters per hour and per gram of catalyst,
total pressure: 1.1 MPa,
temperature increase rate from 150° C. to 450° C.: 5° C./min,
hold at 450° C. for 1 hour.

After the reduction step, the temperature is reduced to 230° C. and the catalyst is placed in contact with n-hexadecane under the following conditions:
feed space velocity of 2 g of n-hexadecane per hour and per gram of catalyst,
mole ratio of hydrogen to n-hexadecane of 10,
total pressure of 1.1 MPa.

The conversion is modified by varying the temperature; and at each temperature hold, two analyses of the effluent are performed, which makes it possible to calculate the catalytic performance and to check the stability of the catalytic performance for said temperature hold. Typically, the temperature is varied between 230° C. and 350° C. in temperature holds of 5° C. The analysis of the effluents is performed integrally by means of an online GC system. The temperature required to reach 50% conversion serves as a descriptor of the activity of the catalyst, while the maximum yield of hexadecane isomers obtained serves as a descriptor of the isomerizing properties of the catalyst. The yield of methane and ethane at 310° C. is used as a descriptor of the hydrogenolysing activity of the catalyst.

Table 1 thus reports the catalytic performance of the catalysts in the hydroconversion of n-hexadecane.

TABLE 1
catalytic performance of the catalysts in the hydroconversion of n-hexadecane

| | | | | | E (in | | |
|---|---|---|---|---|---|---|---|
| | A | | C | | accordance | S | G |
| | (not in | B (in | (not in | D | with the | (not in | (not in |
| Catalyst | accordance) | accordance) | accordance) | (compliant) | invention) | accordance) | accordance) |
| Pt deposition | In | In | In | In | In | Not in | Not in |
| | accordance | accordance | accordance | accordance | accordance | accordance | accordance |
| Heat treatment | Not in | In | Not in | In | In | Not in | In |
| | accordance | accordance | accordance | accordance | accordance | accordance | accordance |
| Temperature at | 278 | 279 | 284 | 281 | 281 | 276 | 278 |
| 50% conversion | | | | | | | |
| (° C.) | | | | | | | |
| Max yield of | 85 | 87 | 86 | 87 | 87 | 83 | 83 |
| isomers (wt %) | | | | | | | |
| Yield of | 0.09 | 0.03 | 0.09 | 0.03 | 0.02 | 0.02 | 0.02 |
| methane and | | | | | | | |
| ethane at 310° C. | | | | | | | |

Catalysts A and B are prepared from the same IZM-2/alumina support, for both solids the Pt deposition protocol is in accordance with the invention, but the heat treatment after deposition of Pt on catalyst A is not in accordance with the invention. It is observed that the catalysts have comparable catalytic activities (one degree difference in activity) but that catalyst B that has undergone a treatment in accordance with the invention has a higher maximum isomerization yield. Catalyst B also has a lower hydrogenolysing activity than catalyst A at 310° C. since the yield of methane and ethane is reduced by a factor of 3.

Catalysts C, D and E are prepared from the same IZM-2/alumina support. For these three solids, the deposition of Pt is also in accordance with the invention, but the heat treatment after deposition of Pt on catalyst C is not in accordance with the invention. It is observed that catalysts D and E in accordance with the invention have a better better activity (three degrees difference). The two catalysts D and E also have a higher maximum isomerization yield than catalyst C. Catalysts D and E also have a lower hydrogenolysing activity than catalyst C at 310° C., since the yield of methane and ethane is reduced by a factor of 3 and 4.5 respectively.

Finally, catalysts F and G are prepared from the same IZM-2/alumina support as catalysts C, D and E. However, for these two catalysts, the Pt deposition protocol is not in accordance with the invention. The heat treatment of catalyst F after deposition of Pt is not in accordance with the invention, whereas that of catalyst G is. It is observed that, in this case, the heat treatment in accordance with the invention does not make it possible to improve the maximum isomerization yield, which is the same for both catalysts. Similarly, the yield of methane and ethane remains the same for both catalysts. Finally, it is observed that the maximum isomerization yields on catalysts F and G not in accordance with the invention are significantly lower than those obtained with catalysts D and E, which are in accordance with the invention and are prepared from the same IZM-2/alumina support as catalysts F and G.

It is therefore clearly noted that the systematic improvement in the maximum isomerization yield is observed for the catalysts in accordance with the invention having both a preferential localization of the Pt on or in the zeolite and a heat treatment in accordance with the invention, and is linked to a decrease in the hydrogenolysing activity of said catalysts.

1. A process for preparing a bifunctional catalyst comprising an acid function constituted by IZM-2 zeolite, a hydrogenating function comprising at least one noble metal from group VIII of the Periodic Table, chosen from platinum and palladium, and a matrix, said process comprising at least the following steps:
i) a step of preparing the support for the catalyst by shaping IZM-2 zeolite with a matrix such that the weight percentage of zeolite is advantageously between 1% and 50% relative to the weight of the support,
ii) a step of depositing at least one noble metal from group VIII of the Periodic Table by impregnation of the support prepared in step i), enabling a solid to be obtained, with an aqueous solution comprising at least the following compounds:
at least one ammoniacal compound chosen from the platinum(II) tetramine salts of formula Pt(NH₃)₄(OH)₂, Pt(NH₃)₄(NO₃)₂ or Pt(NH₃)₄X₂, the platinum(IV)hexamine salts of formula Pt(NH₃)₆X₄; the platinum(IV) halopentamine salts of formula (PtX(NH₃)₅)X₃; the platinum N-tetrahalodiamine salts of formula PtX₄(NH₃)₂; and the halogenated compounds of formula H(Pt(acac)₂X); the palladium(II) salts Pd(NH₃)₄SO₄ or Pd(NH₃)₄X₂, wherein X is a halogen chosen from chlorine, fluorine, bromine and iodine, X preferably being chlorine, and “acac” represents the acetylacetonate group (of empirical formula C₅H₇O₂), an acetylacetone-derived compound,
iii) at least one heat treatment step wherein said solid prepared in step ii) is brought into contact with at least one gas mixture containing oxygen, water, chlorine and/or at least one chlorinated compound, said heat treatment step being carried out between 200° C. and 1100° C.

2. The process as claimed in claim 1, wherein step i) is performed by blending-extrusion.

3. The process as claimed in claim 1, wherein
said matrix used in step i) is alumina.

4. The process as claimed in claim 1, wherein the support obtained on conclusion of step i) is subjected to a drying step performed at a temperature of between 50° C. and 180° C.

5. The process as claimed in claim 1, wherein the X is chlorine.

6. The process as claimed in claim 1, wherein the aqueous solution from step ii) comprises ammoniacal compounds chosen from the platinum(II) tetramine salts of formula Pt(NH₃)₄(OH)₂, Pt(NH₃)₄(NO₃) or Pt(NH₃)₄X₂, the platinum(IV) hexamine salts of formula Pt(NH₃)₆X₄; the platinum(IV) halopentamine salts of formula (PtX(NH₃)₅)X₃; the platinum N-tetrahalodiamine salts of formula PtX₄(NH₃)₂; and the halogenated compounds of formula H(Pt(acac)₂X); X and “acac” having the abovementioned meaning.

7. The process as claimed in claim 6, wherein said solution comprises ammoniacal compounds chosen from the platinum(II) tetramine salts of formula Pt(NH₃)₄(OH)₂, Pt(NH₃)₄(NO₃) or Pt(NH₃)₄X₂.

8. The process as claimed in claim 1, wherein the impregnation solution also contains at least one ammonium salt not containing any noble metals, chosen from ammonium nitrate NH₄NO₃, ammonium chloride NH₄Cl, ammonium sulfate (NH₄)₂SO₄, ammonium hydroxide NH₄OH, ammonium bicarbonate NH₄HCO₃ and ammonium acetate NH₄H₃C₂O₂, alone or as a mixture, and preferably from ammonium nitrate NH₄NO₃, ammonium chloride NH₄Cl and ammonium acetate NH₄H₃C₂O₂, alone or as a mixture.

9. The process as claimed in claim 8, wherein the mole ratio between the ammonium salt and the noble metal is between 0.1 and 400.

10. The process as claimed in claim 1, wherein said heat treatment of step iii) is carried out at a temperature above 300° C. and below 700° C.

11. The process as claimed in claim 1, wherein the chlorinated compound is an inorganic or organic, and preferably organic, chlorinated compound chosen from carbon tetrachloride, dichloropropane, dichloroethane and chloroform.

12. The process as claimed in claim 1, wherein a step wherein the solid from step ii) is brought into contact with a gas containing oxygen but free of chlorine and/or at least one chlorinated compound is used between step ii) and the heat treatment step iii), until the desired temperature for the implementation of step iii) is reached.

13. The process as claimed in claim 12, wherein the temperature for performing step iii) is above 300° C. and below 700° C.

14. A catalyst comprising an acid function constituted by IZM-2 zeolite, a hydrogenating function comprising at least one noble metal from group VIII of the Periodic Table chosen from platinum and palladium, and a matrix, obtained via the process as claimed in claim 1.

15. A process for the isomerization of a paraffinic feedstock containing between 9 and 25 carbon atoms, said process comprising placing said paraffinic feedstock in contact with at least said catalyst as claimed in claim 14, said process being performed at a temperature of from 200° C. to 500° C., a partial pressure of hydrogen of from 0.3 to 5.5 MPa, a total pressure of from 0.45 to 7 MPa, and a feed space velocity, expressed in kg of feedstock introduced per kilogram of catalyst and per hour, of from 0.25 to 30 h⁻¹.

16. The process as claimed in claim 15, wherein said paraffinic feedstock is produced from renewable resources chosen from plant oils, algae oils or algal oils, fish oils and fats of plant or animal origin, or mixtures of such feedstocks.
